(19) United States
(12) Patent Application Publication
(10) Pub. No.: US 2020/0188219 A1
(43) Pub. Date: Jun. 18, 2020

(54) HAND-HELD MASSAGE DEVICE HAVING ERGONOMIC HANDLE

(71) Applicants: Vincent A Piucci, JR., Oakham, MA (US); Barbara A Piucci, Oakham, MA (US)

(72) Inventors: Vincent A Piucci, JR., Oakham, MA (US); Barbara A Piucci, Oakham, MA (US)

(21) Appl. No.: 16/715,239

(22) Filed: Dec. 16, 2019

Related U.S. Application Data
(60) Provisional application No. 62/781,070, filed on Dec. 18, 2018.

(51) Int. Cl. A61H 15/00

(52) U.S. Cl. CPC A61H 15/0092; A61H 2015/0021

(57) ABSTRACT

Embodiments of the innovation relate to a massage device comprising a shaft having a first end and a second end, at least one roller rotatably disposed on the shaft between the first end and the second end, a first handle coupled to the first end of the shaft, the first handle having a substantially spherical portion and a spacer portion disposed between the spherical portion and the first end of the shaft, and a second handle coupled to the second end of the shaft, the second end having a substantially spherical portion and a spacer portion disposed between the spherical portion and the second end of the shaft.

### RELATED APPLICATIONS

This application claims the benefit of U.S. Provisional Patent Application No. 62/781,070 filed Dec. 18, 2018, entitled “Ergonomic Handle and Hand-Held Massage device,” the contents and teachings of which are hereby incorporated by reference in their entirety.

### BACKGROUND

Massage is an ancient art that is practiced in most cultures around the world. The earliest evidence of the practice of human massage dates back to at least 2300 BC. Equine massage was documented in ancient Greece, where horses were massaged prior to battle and during Olympic games as a way to improve their performance. Canine massage is also very old. Julius Caesar was known to have travelled with a personal massage therapist who also massaged his war dogs.

Over the last number of decades, massage has gained widespread acceptance as a therapeutic treatment. This is particularly true in the sports world where terms such as Sports Massage and Equine Sports Massage Therapy have gained common usage. Sports massage is the application of therapeutic massage techniques to relieve sore muscles, reduce and relax muscle spasms and knots, prevent injuries, release endorphins, enhance proprioception, increase flexibility and range of motion, and improve athletic performance. There are numerous massage styles that range from superficial relaxation techniques to deep tissue work.

Massage involves the manipulation of soft tissue in the body. This tissue comprises muscle fibers, fascia, tendons and ligaments. Massage professionals use their hands as well as tools to carry out the massage. Professional massage therapists are trained in the use of various massage techniques. They learn massage routines, how to recognize specific issues, which techniques to use, and how to use them. To become proficient as a massage therapist requires training, practice and understanding.

Many nonprofessionals would like to have the ability to massage their horses, dogs, friends, spouses and even themselves. While most people can rub a muscle and provide some comfort, it is difficult for a nonprofessional to deal with the range of issues that may be encountered. Untrained people simply do not have the knowledge and skills required for effectiveness and safety.

An issue for both professionals and nonprofessionals is fatigue. Using one's hands for massage takes strength. While giving an effective massage, the hands, arms, shoulders, etc. tire and become fatigued. This is especially true when massaging a horse where not only can the individual muscles be extremely large, but when working on an animal of a thousand pounds plus, there is a great deal of tissue to massage. Even professionals who have developed excellent stamina will experience fatigue when massaging multiple horses.

There are tools available to aid in massage. For example, massage rollers are found in the marketplace. The most prevalent are elongated devices with a central shaft and a handle on each end. One or more rollers are disposed on the central shaft between the handles in a manner that allows them to roll on the shaft. The user grips each handle, then presses and rolls the rollers along the tissue with a back and forth motion. This action compresses then extends the tissue, performing a massaging action.

For the professional, a massage device extends reach and leverage, allowing massage to be performed for a longer period of time before becoming fatigued. Since a massage device has more contact area than a human hand, massages can be performed in less time. For the nonprofessional, a massage device can be used without the need for thorough massage training since the roller is easy to use and does not require precise hand manipulation techniques in order to be safe and effective.

### SUMMARY

Conventional massage devices suffer from a variety of deficiencies, particularly with regards to the handles. Massage devices of this type utilize handles that are generally cylindrical in shape, much like a bicycle grip. These grips may have bulges, tapers or other features but the general shape is a cylinder with a blunt end. This handle shape presents certain drawbacks. A cylindrical grip can only be gripped in one manner, that is, to wrap one's hand around the handle with fingers above and thumb below, forcing the hands to remain perpendicular to the roller at all times. This position is fine when massaging a surface that is parallel and square to the user's body, but when performing a massage, this is often not the case. The user must reach around a body being massaged to gain access to a desired area. With the hands in a fixed position, this can put torque and strain on the user's hands, wrists and arms as they compensate to use the massage device in a position that is not parallel and square to their body. This can cause discomfort and fatigue, and can cause the user to put uneven pressure on the tissue being massaged.

An additional drawback to the cylindrical handle is that its length can often get in the way when massaging, for example, a person or dog in a prone position. Cylindrical handles are generally four to five or more inches in length. This can present a problem when attempting to massage the side, for example torso, leg, arm, etc., of a person or dog that is lying down. The extended handle contacts the table or floor and prevents the user from massaging the portions of the body that are near the table or floor. In order to gain access to these areas, the person or dog must be relocated into a different position.

A trigger point is a contracted knot in a muscle caused by overuse, nervous stress, poor circulation and/or buildup of lactic acid. Trigger point pain is hypersensitive and can often refer pain and other sensations to other parts of the body. This results in increased muscle tension causing bracing, clenching, compensation and decreased flexibility. Techniques to alleviate trigger points include the application of pressure and friction to break down the knot.

Trigger point tools are available. Conventional trigger point release tools comprise spherical or rounded surfaces. These surfaces are generally small in diameter, often in the range of ⅞ inch to 1¼ inches, and made of a hard, rigid material. While these are effective, a small diameter tool pressing into a tender trigger point can be painful. This can be problematic when working on an animal. It is not possible to communicate to the animal that the pain we are causing them will, in fact, make them feel better. They can become defensive, which can cause them to react in a manner that is dangerous, such as biting, kicking, etc.

By contrast to conventional devices and tools, embodiments of the innovation relate to an ergonomic handle and hand-held massage device. The innovative handle is configured to provide the user the ability to grip the handle in multiple positions, is short enough to allow access in tight areas, and remains comfortable to use in any position.

The handle of the massage device can be substantially spherical rather than cylindrical in shape. It will be seen that this allows the handle to be gripped not only in a conventional position, as with a cylindrical handle, but also to be held in a diverse variety of alternative positions. The substantially spherical end rests within the user's palm with the fingers gently curled around it, giving it the attributes of a ball and socket joint within the user's hand. As the user reaches to gain access to different locations on the body being massaged, the handle swivels within the hand and provides a natural grip and neutral wrist position in any orientation.

Allowing the wrists to remain in a neutral position, i.e. the hands and wrists are aligned, helps to prevent the user's muscles, tendons, etc. from straining during use, thus alleviating fatigue and reducing the possibility of injury such as repetitive motion injuries. Since the handle is in what is essentially a ball and socket relationship within the palm of the hand, it also requires less force to grip than does a conventional cylindrical handle that is held in place with the force of the user's fingers. This makes the massage device easier and more comfortable to use and alleviates torque and strain on the hands, wrists and arms.

The handle of the massage device can be shorter than a conventional cylindrical handle and still provide an advantageous grip. In general, the spherical handle can be half or less of the length of a conventional handle on a prior art massage device. This helps to gain access to sections of a body being massaged that are close to the surface on which the body is laying. Take, for example, a person lying on their stomach or back on a massage table. More of the side of their torso, the inside or outside of their leg, etc., can be massaged relative to conventional massage devices, since the massage rollers can get closer to the table before the handle contacts the table and prevents the massage device from moving further down. This means that less relocation of a body being massaged is required to gain access to these areas.

The massage device can provide valuable feedback about the condition of the tissue being massaged, due to the soft and easy grip and contact with the sensitive palm of the hand. When, for example, a trigger point is encountered, the “bump” associated with it is transmitted through the handle into the palm of the hand. The trigger point can now be massaged using a rhythmic rolling method, or the handle itself can be used as a trigger point tool to alleviate the issue.

The substantially spherical shape of the handle offers the capability for its use as a trigger point tool, incorporating two massage tools into one device. The trigger point release tool features of the disclosed handle may offer advantages over conventional trigger point devices in that pressure may be distributed over a larger area and provide a more gentle and therefore less painful treatment. In some arrangements, the handle comprises an elastomer, the softness of which enhances the soft and gentle feeling of the trigger point treatment.

In one arrangement of the innovation, a massage device comprises a flexible central shaft and soft, resilient rollers. The soft feel, enhanced feedback, and variable hand positions give the massage device increased feel and control. This massage device provides a more comfortable massage experience for the person or animal being massaged, relative to conventional devices, as well as for the person performing the massage.

Embodiments of the innovation relate to a massage device comprising a shaft having a first end and a second end, at least one roller rotatably disposed on the shaft between the first end and the second end, a first handle coupled to the first end of the shaft, the first handle having a substantially spherical portion and a spacer portion disposed between the spherical portion and the first end of the shaft, and a second handle coupled to the second end of the shaft, the second end having a substantially spherical portion and a spacer portion disposed between the spherical portion and the second end of the shaft.

### BRIEF DESCRIPTION OF THE DRAWINGS

The foregoing and other objects, features and advantages will be apparent from the following description of particular arrangements of the innovation, as illustrated in the accompanying drawings. The drawings are not necessarily to scale, emphasis instead being placed upon illustrating the principles of various arrangements of the innovation.

FIG. 1 illustrates an isometric view of an arrangement of a massage device.

FIG. 2 illustrates a front view of an arrangement of a massage device.

FIG. 3 illustrates an end view of an arrangement of a massage device.

FIG. 4 illustrates an exploded view of an arrangement of a massage device.

FIG. 5 illustrates an isometric view of an arrangement of a roller.

FIG. 6 illustrates a front view of an arrangement of a handle.

FIG. 7 illustrates a cross-sectional view of an arrangement of a handle.

FIG. 8 illustrates an isometric view of an arrangement of a handle.

FIG. 9 illustrates a front view of an arrangement of a handle.

FIG. 10 illustrates a front view of an arrangement of a handle.

FIG. 11 illustrates one end of an arrangement of a massage device within the hand of a user.

FIG. 12 illustrates an arrangement of a massage device within the hands of a user.

FIG. 13 illustrates an arrangement of a massage device within the hands of a user.

FIG. 14 illustrates an arrangement of a massage device within the hands of a user.

FIG. 15 illustrates an arrangement of a massage device within the hands of a user.

FIG. 16 illustrates an arrangement of a massage device within the hands of a user.

FIG. 17 illustrates a front view of a prior art massage device.

FIG. 18 illustrates a prior art massage device within the hands of a user.

FIG. 19 illustrates a prior art massage device within the hands of a user.

### DETAILED DESCRIPTION

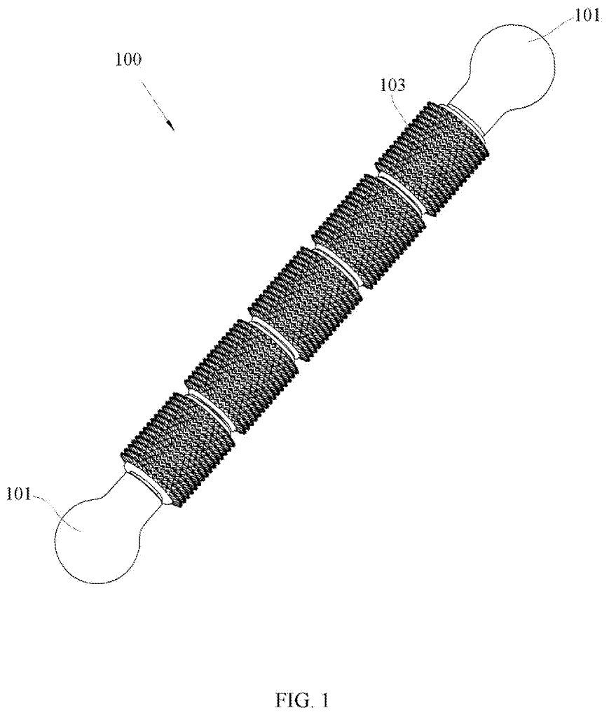

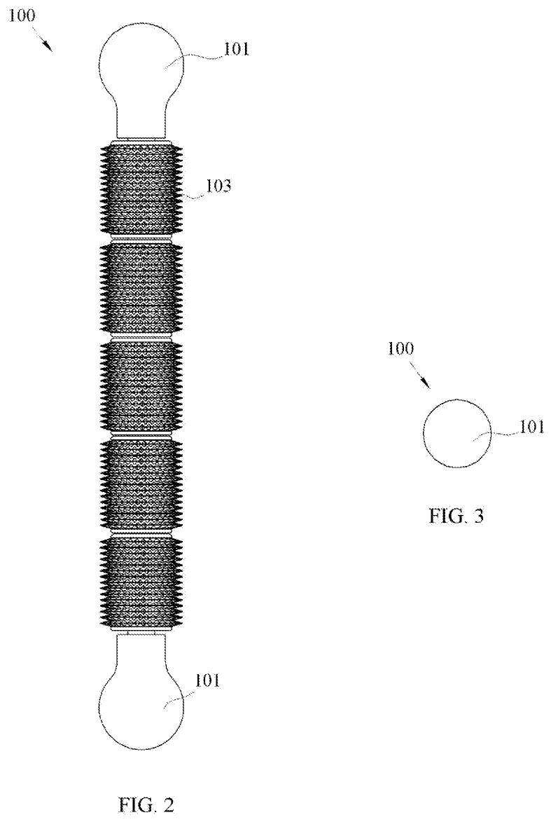

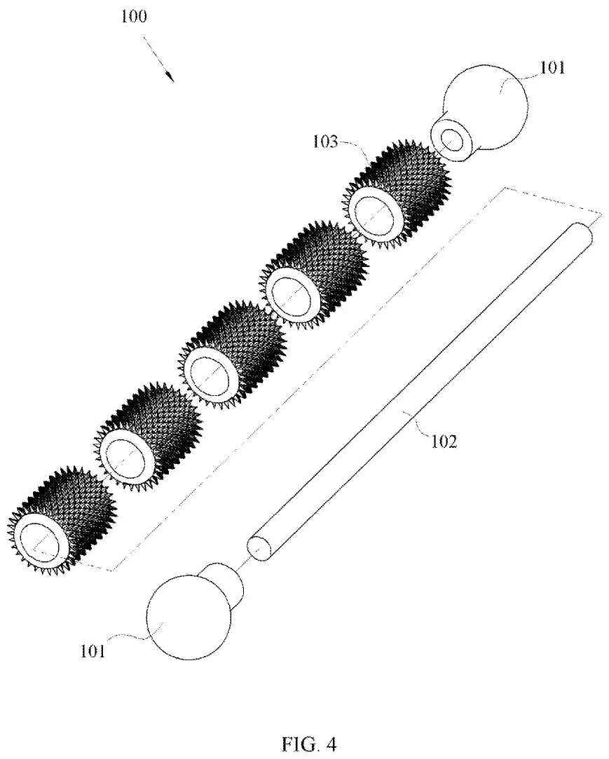

FIGS. 1, 2, 3 and 4 illustrate an isometric view, a front view, an end view and an exploded view, respectively, of an arrangement of a massage device 100 that incorporates ergonomic handles 101. Handles 101 are disposed in a fixed manner at each end of a central shaft 102. One or more rollers 103 are mounted onto the central shaft 102 in a manner that allows them to rotate around the axis of the central shaft 102. In use, the user holds the massage device 100 by the handles 101 and rolls the massage device 100 with a desired force across the tissue being massaged. The rollers 103 rotate about the longitudinal axis of the central shaft 102 as the massage device 100 is rolled. The rollers 103 press into the tissue as they roll and provide a massaging action to the tissue.

The handle 101 can be manufactured from a variety of materials. In one arrangement, the handle 101 is made from an elastomeric material. This can be a natural or synthetic rubber, a thermoplastic elastomer such as polyurethane, EPDM, etc., or other suitable material. The hardness of an elastomer utilized in the handle 101 can be chosen for a desired feel and stiffness. Generally, the hardness is within the range of between about 40 and 90 durometer Shore A. In some arrangements, the hardness is within the range of between about 60 and 70 durometer Shore A providing a preferred overall feel and performance. If a soft feel is not desired, a rigid material may be used. Rigid materials may include polymers such as ABS or other plastics, plastic blends, composites, wood or other suitable material. Combinations of materials may be used, for example, a handle 101 with a rigid polymer base and elastomeric overmold. The handle 101 of the massage device 100 is not limited by any material or manufacturing process.

The central shaft 102 can be manufactured from materials including plastics, metals, composites or other suitable materials. One arrangement uses a polymer material such as acetal, Nylon, etc. An amount of flexibility can be provided by the material, as it allows the massage device 100 to conform to the tissue being massaged, increasing the roller 103 contact area. This allows for a more thorough massage and increased comfort during the massage, relative to conventional devices. The amount of flexibility is determined by the specific material used and the length and diameter of the central shaft 102. In the illustrated arrangement, the central shaft 102 can have a length between the handles 101 of approximately ten inches, and a diameter of 9/16 inch. This provides a level of stiffness that allows the massage device 100 to flex under pressure but still maintain enough stiffness to provide as deep a massage as desired. Longer or shorter massage devices 100 may utilize larger or smaller diameter central shafts 102 or different materials in order to generate the desired stiffness. Additionally, many thermoplastic polymers have a relatively low coefficient of friction which provides a suitable bearing surface in arrangements where the rollers 103 roll directly on the central shaft 102. The central shaft 102 of the massage device 100 is not limited to any material or diameter.

The rollers 103 can be of a material and configuration to suit a desired feel and operation. The example, FIGS. 1, 2, and 4, illustrate a massage device 100 having five rollers. Other arrangements can use a single long roller, or any combination of multiple rollers. The number and length of rollers 103 can be determined by the length of the massage device 100 and by design and operational preferences. In the arrangement shown, the rollers 103 are each approximately two inches long, creating a total roller contact length of approximately ten inches. Any number or configuration of rollers 103, and any length of the massage device 100 may be used and are within the scope of the present innovation.

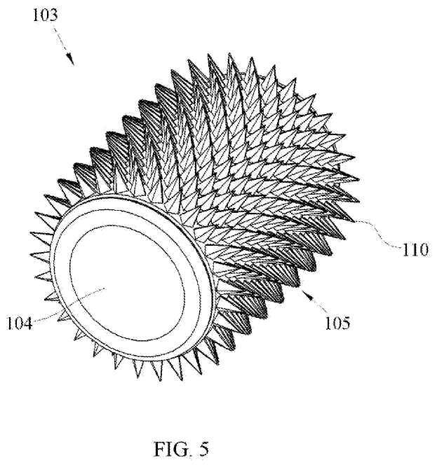

FIG. 5 illustrates an isometric view of an arrangement of a roller 103. The roller 103 includes an inner spool 104 and an outer covering 105. The inner spool 104 supports the outer covering 105 and acts as a bearing surface on the central shaft 102. The inner spool 104 defines an opening extending along a longitudinal axis of the roller 103 with an inner diameter configured to fit over the outer diameter of the central shaft 102, allowing it to roll freely. Materials for the inner spool 104 of the roller 103 can be chosen for their friction coefficient and durability for use as a bearing surface. Materials such as Nylon and acetal can be used because of their performance capability and relatively low cost, but other materials can be used, such as other plastic materials, coated metals, composites etc.

The outer covering 105 of the roller 103 can be configured as a soft, resilient material, such as an elastomeric material. This can be, for example, a natural rubber material, a plastic or thermoplastic elastomer. The hardness of the elastomer can be chosen to provide a particular feeling or sensation to the tissue being massaged. In one arrangement, the hardness is within the range of between about 20 and 70 durometer Shore A. In one arrangement, the hardness is within the range of between about 35 and 45 durometer Shore A. The outer covering 105 is shown with multiple small protrusions, or nubs 110, around the roller's perimeter. These nubs 110 provide a soft, compressible contact surface. They aid in providing a gentle, soothing massage. When massaging an animal that has a coat of hair or fur, such as a horse or a dog, these nubs 110 penetrate the coat and help to give the animal a comfortable massage without the need to increase massage pressure to get through the coat. A roller 103 with a smooth surface or with differing patterns of raised or lowered portions is also within the scope of this innovation.

The interaction between the roller 103 and central shaft 102 defines a bearing system in the massage device 100. In one arrangement, the outer diameter of the shaft 102 is substantially smaller than the inner diameter of the inner spool 104 of the rollers 103. This creates a gap between the inner diameter of the inner spool 104 of the rollers 103 and the outer diameter of the shaft 102. This arrangement allows the rollers 103 to rotate freely about the shaft 102 and to translate both axially and radially within the limits of the dimensions chosen for a particular arrangement. This design aids in providing the ability of the rollers 103 to follow the contours of the tissue being massaged. Further, the massage device 100 is often used to massage horses, dogs and other animals. These animals have hair or fur that may be shed during a massage. When used in a barn environment, the massage device 100 is exposed to dirt, dust and other contaminants. A tight fitting bearing system may be susceptible to becoming clogged with hair and other contaminants. The loose fitting system of the present innovation allows the contaminants to fall out of the spaces between the rollers 103 and shaft 102. If this area does get dirty, the spacing allows for easy cleaning as water can be used to flush the contaminants out of the space. In one arrangement, the outer diameter of the central shaft 102 is approximately 9/16 inch, and the inner diameter of the inner spool 104 is approximately ⅞ inch. Other interfaces between the central shaft 102 and roller 103, including the use of precision bushings, roller bearings, etc. are anticipated and are within the scope of this innovation.

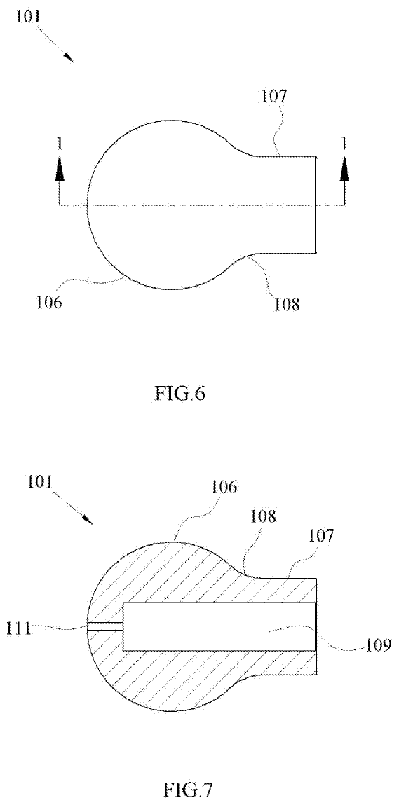

FIG. 6 illustrates a front view and FIG. 7 illustrates a cross sectional view taken through Section 1-1 of FIG. 6, of an arrangement of a handle 101 of the massage device 100. A substantially spherical portion 106 comprises the end of the handle. In the illustrated arrangement, the diameter of the spherical portion 106 is approximately 1¾ inches. Spherical diameters of different sizes may be used, for example, to tailor the handle to fit larger or smaller hands, and still be within the scope of the present innovation. While shown as a sphere having a constant radius in this arrangement, alternative shapes may be used, for example, spheres with flattened sections or compound radii, and still be considered substantially spherical and within the scope of the present innovation.

In order to prevent the user's hands from contacting the rotating roller 103 during use, a spacing device can be provided to separate the substantially spherical portion 106 of the handle 101 from the roller 103 that is adjacent to the handle 101. In the illustrated arrangement, a cylindrical spacing device 107 is incorporated into the handle 101 and acts as a spacer between the substantially spherical portion 106 and an adjacent roller 103. This allows the user's hand to encompass the spherical portion 106, remain at a distance from and not come into contact with an adjacent roller 103. In the illustrated arrangement, the diameter of the cylindrical spacer portion 107 is approximately 1 inch, however the diameter can be selected based on the diameter of the central shaft 102 and other factors. A radiused fillet portion 108 blends the spherical portion 106 of the handle 101 into the cylindrical portion 107 of the handle 101 to provide a transition that is comfortable within the user's hand. As shown, this fillet portion comprises a ½ inch radius. A smaller or larger radius can be used. The overall length of the handle 101 as illustrated is approximately 2⅜ inches, but this length may be altered and chosen based on factors that include the spherical diameter, the handle material, user's hand size, design preference, etc. Other designs and construction methods are within the scope of this innovation. These include, but are not limited to, a 2-piece handle comprising a substantially spherical handle component and a cylindrical, spherical, or alternatively shaped spacer, or a one-piece handle utilizing a spacer portion of a shape other than cylindrical.

In order to attach the handle 101 to the central shaft 102, an internal cavity 109 can be defined by the handle 101 which is configured to engage with the shaft 102. The size (i.e., length and diameter) of the cavity 109 relative to the size of the shaft 102 can be dependent on the materials used and the type of connection desired. This can be an interference fit or a slip fit. In one arrangement, when using an elastomeric handle 101, an interference fit can be utilized. Elastomeric materials are resilient and compressible, so large interferences may be used. For example, with a shaft 102 of 9/16 inch diameter, the cavity 109 may be ½ inch diameter, giving 1/16 inch total interference. Once the handle 101 is pressed onto the central shaft 102, the compression of the handle material firmly holds the handle 101 onto the central shaft 102. The amount of interference may be adjusted based on the hardness of the elastomer and the desired fit. It is helpful with a tight interference fit to provide a mechanism to relieve the air within the handle cavity 109 as the handle 101 is pressed onto the shaft 102, otherwise the shaft 102 may act as a piston, compressing the air inside the cavity 109, making it difficult to install the handle 101. In one arrangement, the handle 101 can define a vent 111 that extends between the cavity 109 and an end of the handle 101, thereby providing air trapped between the handle 101 and shaft 102 a passage to the atmosphere. Other methods of venting may be used, including internal grooves, etc.

If a rigid handle material is used, an interference fit can be on the order of a few thousandths of an inch, and can depend upon the relative hardness of the handle 101 and central shaft 102, as well as the desired fit. Alternatively, a slip fit can be used and can utilize an attachment mechanism to secure the handle 101 to the shaft 102. For example, the handle 101 can be glued onto the shaft 102, can be pinned in place, or can include screw threads or other attachment mechanisms.

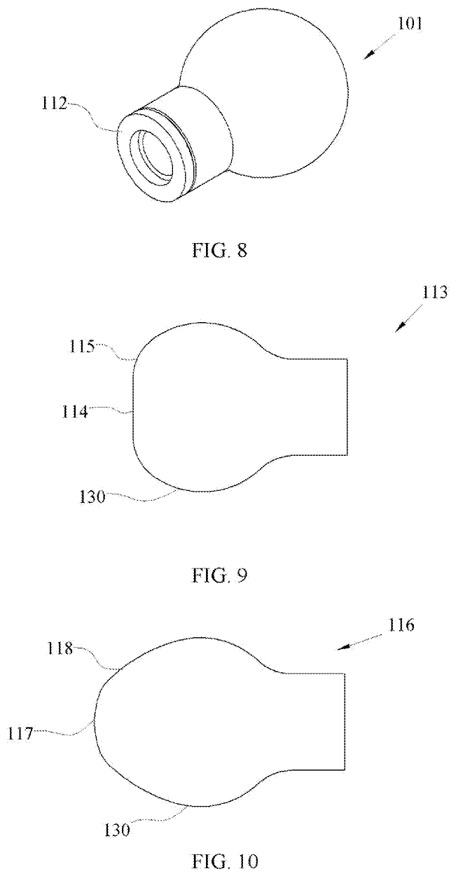

FIG. 8 illustrates an isometric view of a handle 101 that incorporates a bearing segment 112 that acts as a bearing surface between the handle 101 and adjacent roller 103. This bearing segment 112 may be used with any handle 101 material, but is particularly useful when the handle 101 is made from an elastomer. The elastomer's rubber-like surface and texture has a high coefficient of friction. This can cause friction between the handle 101 and adjacent roller 103, as the massage device 100 is being used, and may impede the roller's 103 ability to roll smoothly when it rubs against the handle 101. The bearing segment 112 may be made from a generally rigid, slippery material such as Nylon, acetal or other material with a relatively low coefficient of friction. With the bearing segment 112 in place, the roller 103 rubs against the slippery bearing segment 112 as the massage device 100 is being used, and the roller 103 can roll freely. The bearing segment 112 can comprise a separate component, or may be incorporated as an integral part of the handle 101.

The handle 101, when used with the massage device 100 as disclosed, provides tactile feedback about the condition of the tissue being massaged. Because of the easy grip and contact with the sensitive palm of the hand, when a trigger point is encountered, the “bump” or tightness associated with the trigger point is transmitted through the handle into the palm of the hand. When a trigger point is encountered, the handle 101 may be used as a trigger point release tool to aid in relieving the pain and discomfort associated with the condition. When pressed into a trigger point, the pressure is dissipated over the area of the generally spherical portion 106 of the handle 101. If the handle 101 is elastomeric, it has a degree of softness and gentleness that a hard tool cannot typically provide. The result is a gentle, soothing release that will effectively release the trigger point in a comfortable manner.

FIG. 9 illustrates a front view of an alternative arrangement of a handle 113 that can be used with the massage device 100 as a trigger point release tool. In this arrangement, an end portion 114 of the handle 113 has been flattened such that the flat surface of the end portion 114 is substantially perpendicular to a longitudinal axis of the handle 113. A transitional radius portion 115 defined by the handle 113 can blend the flat end portion 114 into the handle's major diameter portion 130 to produce a smooth transition. When used as a trigger point release tool, the flattened end portion 114 or transitional radius portion 115, as well as the major diameter portion 130 can be selectively pressed into the tissue to provide an alternative contact and therefore, different penetration into the trigger point. In the illustrated arrangement, the handle major diameter portion 130 can be 1¾ inch inches, approximately 5/32 inch has been removed from the end to produce the flattened end portion 114, and the transitional radius portion 115 is ½ inch radius.

FIG. 10 illustrates a front view of an alternative arrangement of a handle 116 that can be used with the massage device 100 as a trigger point release tool. In this arrangement, the end portion 117 of the handle 116 has been elongated relative to the major diameter portion 130 of the handle 116. When used as a trigger point release tool, any of the elongated end portion 117, the transitional radius portion 118 or the major diameter 130 of the handle 116 can be utilized to produce a desired penetration and feeling to the trigger point. In the illustrated arrangement, the handle major diameter 130 is 1¾ inch inches, the elongated end portion 117 has been lengthened by 7/32 inch with a radius of ⅞ inch, and the transitional radius portion 118 is 1⅜ inch radius. For both the FIG. 9 and FIG. 10 arrangements, the dimensions herein are for reference only, and can be modified as desired. These modifications to the spherical handle are minor and do not impede the ability of the handle and user's hand to function as a ball and socket arrangement. These arrangements are exemplary and demonstrate that reasonable modifications can be made to the spherical handle, for the purposes of creating a desired trigger point tool, and still be considered as substantially spherical within the scope of the present innovation.

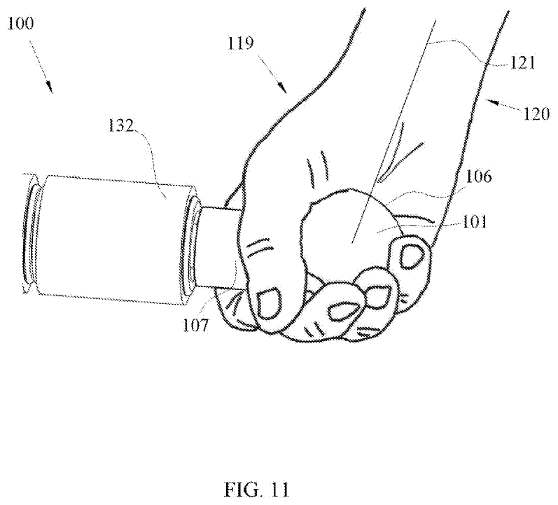

FIG. 11 illustrates the manner in which the handle 101 of the massage device 100 can fit within a hand 119 of the user. The handle 101 fits comfortably within the palm of the hand 119 and contours to the naturally semi-spherical shape created within the palm as the fingers are curled around the handle 101. This creates a ball and socket type of interaction between the hand 119 and the substantially spherical portion 106 of the handle 101. A light grip around the handle 101 with the thumb and fingers is all that is needed to securely grip the handle 101 and use the massage device 100. This can provide a relatively natural feeling and comfortable grip. The cylindrical spacer portion 107 keeps the hand 119 from contacting the adjacent roller 132 as the massage device 100 is used and the roller 132 rotates. Note that in this and the following Figures, the roller 132 is illustrated with a smooth surface, i.e. without the nubs 110 of the of the FIG. 5 roller 103. This is done for clarity in the Figures and to illustrate an alternative roller arrangement that is within the scope of this disclosure.

The ball and socket type of grip allows the hand 119 to swivel through unlimited positions so that the wrist 120 can remain in a neutral, relaxed position, aligned with the hand 119 while using the massage device 100. As shown in FIG. 11, a line 121 drawn from the center of the spherical portion 106 of the handle 101 through the center of the wrist 120 and into the arm is a straight line, indicating that the hand 119 and wrist 120 are aligned and co-linear. The ability to keep hand 119 and wrist 120 aligned indicates that there is minimal, if any, ulnar or radial deviation, that is, flexing of the wrist from side to side. Maintaining this neutral alignment while using the massage device 100 keeps the muscles and tendons within the user's hand 119, wrist 120 and arms relaxed. This helps to alleviate the user's fatigue, prevents soreness and reduces the possibility of repetitive motion injuries, such as carpal tunnel syndrome, etc.

FIGS. 12 through 16 illustrate some of the variety of hand positions that are attainable with the handle 101 of the massage device 100. FIG. 12 illustrates a hand position that works well when massaging a tissue surface that is generally facing and parallel to the user's shoulders. It can be seen that the user's hands 119 are rotated slightly outward on the handles 101, that is, not exactly perpendicular to the massage device 100. This slight rotation compensates for the difference between the width of the massage device 100 and the wider width of the user's shoulders, allowing the wrists 120 to maintain a neutral orientation that is aligned with the hands.

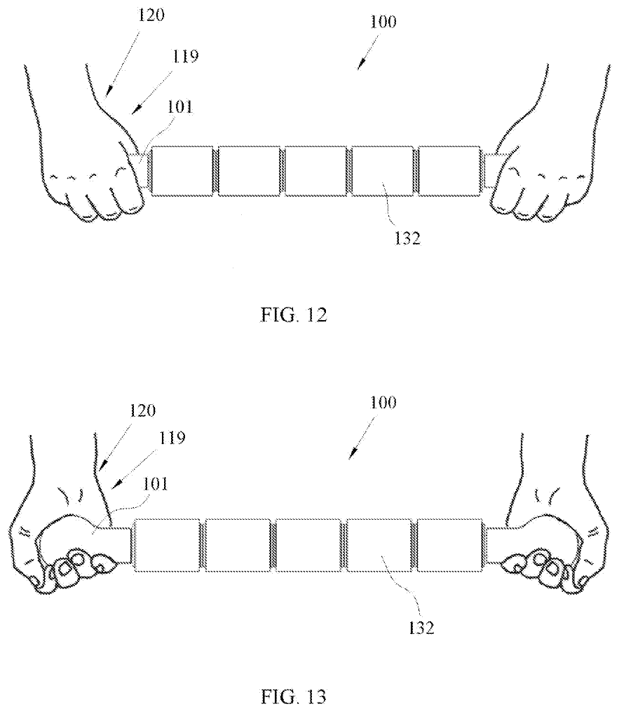

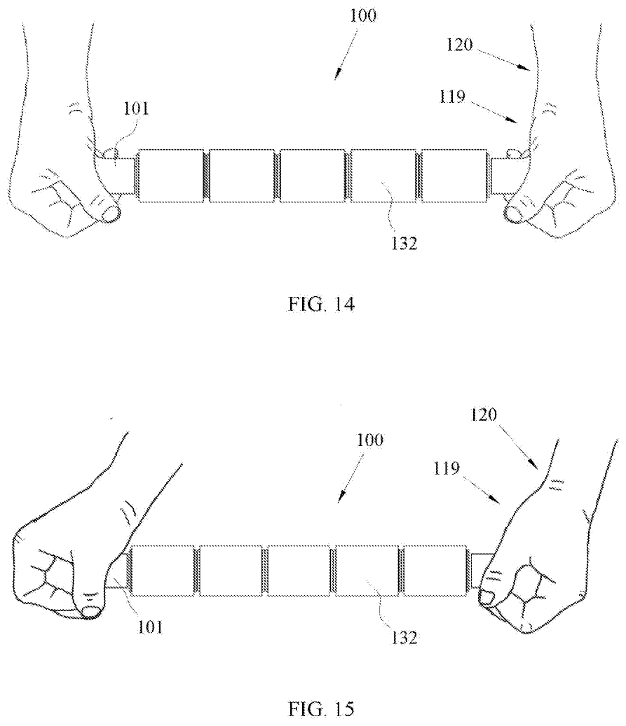

FIG. 13 illustrates an inverted grip that is useful when massaging surfaces that face away from, but are generally parallel to the user, such as the back of a leg, etc. Again, this grip allows a neutral wrist orientation. FIG. 14 illustrates a grip that provides a handy and comfortable position for use on a variety of massage surfaces. This is particularly useful when massaging a person or dog that is laying on a table or floor, as it allows the shortest distance between the hand 119 and the rollers 132 to provide the best access to the side tissue surfaces. Again, note the neutral position of the wrists.

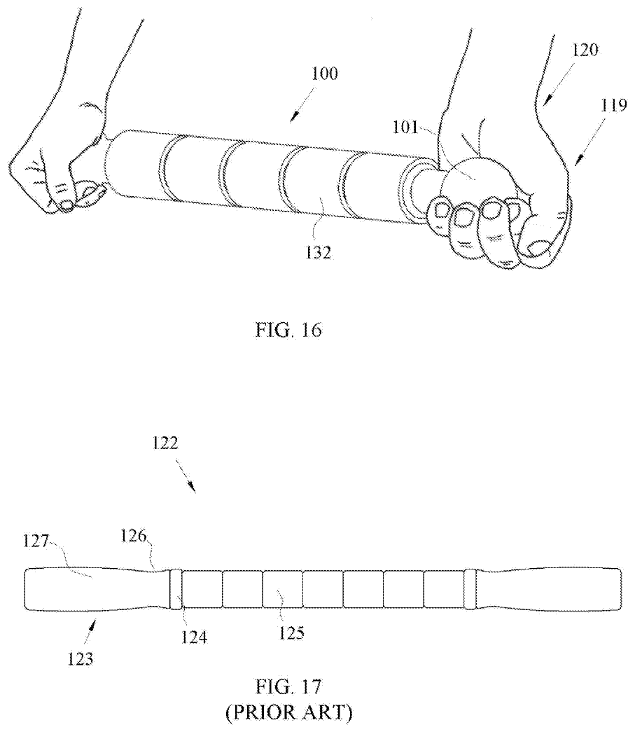

FIGS. 15 and 16 illustrate additional alternative hand positions that allow the user to maintain a comfortable grip and neutral wrist position. It can be seen that the substantially spherical handle 101 can rotate within the hand to maintain a neutral wrist position. These figures illustrate examples of certain grip positions. In use, these positions as well as others may be used during the course of a massage. In fact, the hand position can constantly change during a massage, and even during a massage stroke, in order to keep a relaxed, natural wrist position. As will be seen, this is not possible with conventional massage devices.

FIG. 17 illustrates a front view of a conventional massage roller device 122. This prior art roller device 122 is exemplary and typical of many conventional devices currently available. In it can be seen the handles 123, spacers 124 and rollers 125. In this arrangement, the handle 123 does have some shape, that is, a narrowed section 126 and a bulged section 127, that help it to conform to a user's hand, however, it is generally cylindrical in shape.

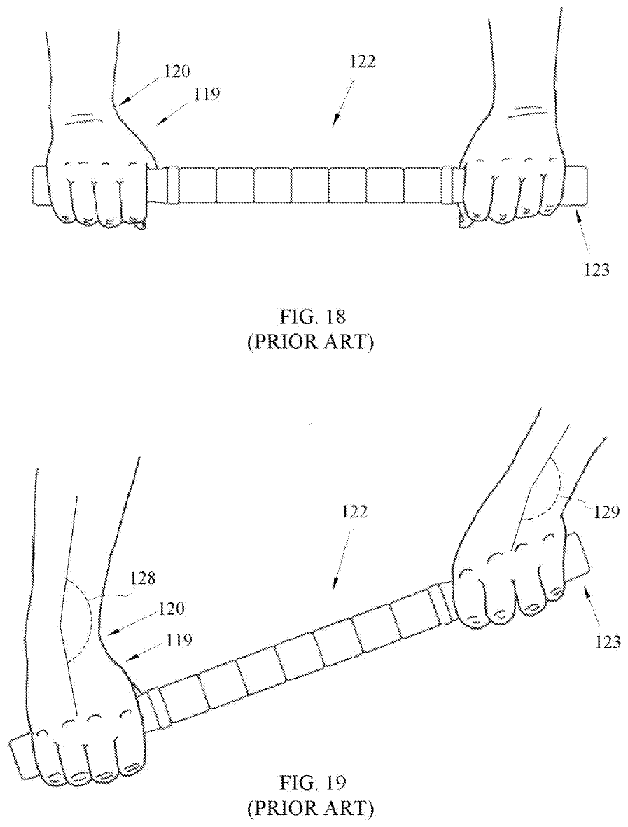

FIG. 18 illustrates the method of gripping this prior art device 122. This is essentially the only grip method that is available with the conventional device. The wrists 120 are generally aligned with the hands 119, although the forearms and elbows must be rotated inward to get the hands 119 into a position to grip the cylindrical handles 123, due to the difference in width between the massage device 122 and the user's shoulders. This generally aligned position only remains in effect if the tissue being massaged is parallel to the user's shoulders which, when massaging a person or animal is often not the case.

FIG. 19 illustrates the result of angling the prior art massage device 122 in order to reach a tissue being massaged that is not directly in front of and parallel to the user's shoulders. A line drawn from the center of the handle 123 through the center of the wrist 120 and into the arms creates angles 128, 129 between the hands and wrists. This misalignment puts pressure on the wrists and forces the fingers to grip the handles 123 more tightly in order to maintain hold. This results in a tightening of the muscles in the hands, arms and shoulders that can lead to muscle fatigue and leaves the user susceptible to injury, such as muscle strain, repetitive motion injury, etc. An end grip, such as illustrated on the massage device 100 of FIG. 14, can be attained by placing the hands over the blunt end of the cylindrical handle 127. This is uncomfortable for the user, and also extends the length of the already long handle, further limiting access to side surfaces near the table, floor, etc.

With reference to FIG. 1, for example, the handle 101 of the massage device 100 has the ability to be used as a trigger point release tool. Trigger point release tools are common in the art and are generally separate, hand-held tools. When a trigger point, such as a muscular knot, lactic acid build-up or other nodule is found, the trigger point release tool is pressed into the affected area to disrupt the nodule and release the trigger point. This is normally accomplished with multiple press and release cycles using varying pressure. The handle 101 of the massage device 100 can be used for this purpose. To use the trigger point function, one hand 119 may grip a handle 101 at one end, and the second hand may grip the rollers 103. When a trigger point is found, the massage device 100 can be held in this manner and the opposite handle 101 can be used as the trigger point release tool, wherein said handle 101 can be pressed into the trigger point to release it.

The following is a description of a method for using the handle 101 as a trigger point release tool. Hold the massage device 100 in a manner as described. Gently, slowly press the handle 101 into the trigger point until resistance is felt, hold for six to ten seconds then slowly release the pressure. Move the tool one handle width to the right and repeat. Move the tool one handle width below and repeat. Move the tool one handle width to the left and repeat. This forms a square of releasing pressure that aids and encourages the release of tension that is held in the tissue. Having a trigger point release tool as an integral part of the massage device 100 provides the advantage that one tool may be used for both a rolling massage and trigger point release.

Variations in the shape of the handle 101 are anticipated and within the scope of this disclosure. In some arrangements there may be a different handle arrangement on each end of the massage device 100. While some of these modified shapes are not truly spherical, i.e. a constant diameter, they are, within the scope of this disclosure, considered to be substantially spherical.

While various arrangements of the innovation have been particularly shown and described, it will be understood by those skilled in the art that various changes in form and details may be made therein without departing from the spirit and scope of the innovation as defined by the appended claims.

1. A massage device comprising:
a shaft having a first end and a second end;
at least one roller rotatably disposed on the shaft between the first end and the second end;
a first handle coupled to the first end of the shaft, the first handle having a substantially spherical portion and a spacer portion disposed between the spherical portion and the first end of the shaft; and
a second handle coupled to the second end of the shaft, the second handle having a substantially spherical portion and a spacer portion disposed between the spherical portion and the second end of the shaft.

2. The massage device of claim 1 wherein the substantially spherical portion of at least one of the first handle and the second handle defines a substantially constant radius.

3. The massage device of claim 1 wherein the substantially spherical portion of at least one of the first handle and the second handle comprises a flattened end portion.

4. The massage device of claim 1 wherein the substantially spherical portion of at least one of the first handle and the second handle comprises an elongated end portion.

5. The massage device of claim 1 wherein at least one of the first handle and the second handle comprises a rigid material.

6. The massage device of claim 1 wherein at least one of the first handle and the second handle comprises an elastomeric material.

7. The massage device of claim 6, wherein the elastomeric material of the at least one of the first handle and the second handle comprises a hardness within the range of between about 40 durometer Shore A and 90 durometer Shore A.

8. The massage device of claim 6, wherein the elastomeric material of the at least one of the first handle and the second handle comprises a hardness within the range of between about 60 durometer Shore A and 70 durometer Shore A.

9. The massage device of claim 1 wherein the at least one roller comprises a spool and an elastomeric covering disposed about an outer periphery of the spool.

10. The massage device of claim 9, wherein the elastomeric covering comprises a hardness within the range of between about 20 durometer Shore A and 70 durometer Shore A.

11. The massage device of claim 9, wherein the elastomeric covering comprises a hardness within the range of between about 35 durometer Shore A and 45 durometer Shore A.

12. The massage device of claim 1 wherein the shaft comprises a polymeric material.

13. The massage device of claim 1 wherein an inner diameter of the at least one roller is larger than an outer diameter of the shaft, the at least one roller and the shaft defining a gap therebetween.

14. The massage device of claim 1, wherein the first handle defines a cavity configured to engage the first end of the shaft.

15. The massage device of claim 1, wherein the second handle defines a cavity configured to engage the second end of the shaft.

16. A massage device comprising:
a shaft having a first end and a second end;
a first handle coupled to the first end of the shaft, the first handle having a first substantially spherical portion;
a second handle coupled to the second end of the shaft, the second handle having a second substantially spherical portion; and
at least one roller rotatably disposed on the shaft between the first handle and the second handle.

17. The massage device of claim 16 wherein the substantially spherical portion of at least one of the first handle and the second handle defines a substantially constant radius.

18. The massage device of claim 16 wherein the substantially spherical portion of at least one of the first handle and the second handle comprises a flattened end portion.

19. The massage device of claim 16 wherein the substantially spherical portion of at least one of the first handle and the second handle comprises an elongated end portion.

20. The massage device of claim 16 wherein;
the first handle comprises a spacer portion disposed between the spherical portion and the first end of the shaft; and
the second handle comprises a spacer portion disposed between the spherical portion and the second end of the shaft.
